(19) United States
(12) Patent Application Publication
(10) Pub. No.: US 2009/0230657 A1
(43) Pub. Date: Sep. 17, 2009

(54) Hitching Mechanism

(76) Inventor: David Miller, Warrenton, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/046,217

(22) Filed: Mar. 11, 2008

(51) Int. Cl. B60D 1/36

(52) U.S. Cl. 280/515; 172/439; 172/1

(57) ABSTRACT

An apparatus and a method providing for improved hitching of a towed implement to a tractor. The apparatus and method are of most use in small connections such as to a lawn tractor and provide for a handgrip to improve ease of moving the implement by hand and a hitching mechanism which serves to allow for the same hand to raise the hitch pin, engage the hitch, and then lower the hitch pin.

### BACKGROUND

1. Field of the Invention

This invention relates to a hitching mechanism for attaching the yoke of an implement to a tractor. In particular, a mechanism which provides a handgrip and allows for a hitch pin connection to be made one handed and without concern over loss of the pin.

2. Description of the Related Art

It is common for towed objects or “implements” to utilize connection from a yoke on the implement to a tow hitch on a tractor which is to be used to pull it. Connections between the yoke and the tractor generally involve at least some flexibility in the connection to allow for the connection to move as the combination of the two objects turns or traverses un-level terrain.

In many motor vehicles, a ball hitch is used where the hitch includes a raised sphere or ball, that is placed internal to a rounded opening on the yoke. The connection provides that the two items generally cannot separate without the yoke being raised up from the ball. This system can be very effective for certain types of towing. Alternatively, trucks and other large trailers often use a flanged pin which is designed to interconnect into a horseshoe-shaped hitch. This allows for the pin to be pushed into position, and then a locking mechanism engaged to hold it.

While these systems work well in the on-road motor vehicle context. The systems are often way too heavy and complex to be used in more simple implement connections for vehicles usually used off roads, particularly residential garden vehicles. One such type of connection comes about from the use of a garden, lawn, or similar light duty tractor to which dump boxes, sweepers, baggers or other implements can be attached. In these fairly small machines, it is common to use a hitch pin to connect the implement to the tractor.

A hitch pin is a pretty basic connection utilizing connectors on the yoke of the implement and on the rear of the tractor and a “pin” that makes the interconnection between the connectors. The connection usually comprises each of the yoke and the tractor having plates with holes through them generally with one of the two having two plates with holes and the other having a single plate with a hole. The plates on the yoke and hitch are arranged so that the holes are aligned and the plates are interleaved (if two or more are present on either piece) with the single plate being between the two plates. A generally cylindrical pin is then pushed through all the holes. The pin will generally be bolt-shaped having a top flange or similar object to prevent it from passing completely through the holes. The pin therefore allows rotational motion of the yoke to the hitch in a plane parallel to the attaching plates, but the plates generally prevent up and down motion which could push the pin loose, while the pin also inhibits side to side lateral motion. Thus, a simple connection for towing is provided. In some embodiments, the pin may include a hole toward the end opposing the top flange through which a cotter pin or other object may be placed to inhibit unintended removal of the hitch pin by bouncing, vibration, or similar activities.

While this system has advantages of simplicity and relatively easy construction, it does have some problems. In the first instance, it can be easy to lose the hitch pin which may be separable from the hitch. To deal with this problem, a chain is often used to hold the pin to either the hitch or yoke.

Still further problems result in the connection due to the need to have to maneuver multiple parts to make the connection. Because such systems are often used with relatively small machinery, as opposed to systems on larger machinery, the implements often do not have supports which hold the yoke at an upward position so that the hitch can be maneuvered to it. Instead, it is often the case that the tractor will be parked, and then the user will hand maneuver the implement using the yoke to align the structures and insert the pin.

Moving the implement by pulling on the yoke by hand (especially since the yoke is usually designed for mechanical and not hand pulling), positioning the structures, and then holding them in place while getting the pin and getting the pin through the holes can be very difficult. In some cases, the user simply does not have enough hands as they may need two hands to position the rather unwieldy yoke to the hitch, and a third hand to hold and position the pin. Because of this problem, the user often has to rely on positioning the yoke and hitch, and then leave it not quite supported while inserting the pin. This can result in movement, meaning that the pin will no longer interconnect and the pieces have to be realigned causing unnecessary headaches. In particularly troublesome scenarios the yoke may slip relative to the tractor before it is secured, resulting in a potential danger.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are, among other things, is a hitching mechanism which utilizes a hitch pin type of connection, but provides for one handed operation of the pin connection mechanism. The system also is generally adapted to provide for easier hand transport of the yoke and implement to the hitch, and easier positioning of the yoke on the hitch.

There is described herein, among other things, a hitching mechanism comprising a handgrip, such handgrip being connected to a yoke such that an implement can be moved by hand by pulling on the handle; a hitch pin, said hitch pin being capable of generally linear movement relative to said yoke such that said hitch pin can move between a closed position, where it extends across a gap, and an open position where it does not extend across said gap; a lever, said lever being able to move said hitch pin from said closed to said open position; and a biasing mechanism, said biasing mechanism biasing said hitch pin to said closed position; wherein, a user can grasp said handgrip and operate said lever with a single hand.

In an embodiment, the handgrip is generally part of a rectilinear structure attached to said yoke.

In another embodiment, the hitching mechanism is placed on a shim plate such that said gap is between said yoke and said shim plate.

In another embodiment, the biasing system comprises a coiled spring.

In various embodiments, the lever may pivot about a point or may slide in a generally linear fashion along with said hitch pin.

In a still further embodiment, the mechanism further comprises a hitch mount which holds said hitch pin. The mechanism may be retrofitted to an existing yoke having a hitch pin connector including an existing hitch pin and said existing hitch pin is attached to said hitch mount.

In a still further embodiment, the user operates said lever by opening or closing their fist while said lever and said handgrip are in their hand. This operation may comprise the lever moving toward said handgrip when said hitch pin is moved to said open position, the motion being generally within a plane including a longitudinal dimension of said handgrip and a longitudinal dimension of said hitch pin.

There is also described a system for hitching an implement to a tractor, the system comprising: an implement including a yoke; and a hitching mechanism attached to said yoke, said mechanism including a handgrip, said handgrip being designed for pulling said implement by hand, two plates separated by a gap, each of said plates including a hole; a hitch pin, said hitch pin being capable of moving from a closed position where said hitch pin engages both said holes and crosses said gap, and an open position where said hitch pin does not cross said gap, a biasing mechanism for biasing said hitch pin into said closed position, and a lever, said lever being attached to said hitch pin and capable of movement in a generally linear fashion to move said hitch pin from said closed to said open position.

In an embodiment, the system further comprises a tractor, such as, but not limited to, a garden tractor or a riding lawn mower, said tractor having a hitch plate with a hole, said hole being engaged by said hitch pin when said implement is attached to said tractor.

In a further embodiment of the system, the lever is engaged by a user's hand which is also in contact with said handgrip. The lever may be moved by making a fist with said user's hand.

There is also described herein, a method for hitching an implement to a tractor, the method comprising: providing an implement including a yoke and a tractor; supplying on said yoke a hitching mechanism, said mechanism including: a handgrip, said handgrip being designed for pulling said implement by hand; two plates separated by a gap, each of said plates including a hole; a hitch pin, said hitch pin being capable of moving from a closed position where said hitch pin engages both said holes and crosses said gap, and an open position where said hitch pin does not cross said gap; a biasing mechanism for biasing said hitch pin into said closed position, and a lever, said lever being attached to said hitch pin and capable of movement in a generally linear fashion to move said hitch pin from said closed to said open position, grasping said handgrip with a user's hand; grasping said lever with said user's hand; said user's hand moving said lever to move said hitch pin to said open position; placing a hitch plate on a tractor, said hitch plate including a hole in said gap; and allowing said biasing member to bias said hitch pin into said closed position, said hitch pin extending through said hole once so biased.

### BRIEF DESCRIPTION OF THE DRAWINGS

FIG. 1 shows a perspective view of a first embodiment of a hitching mechanism in place on the yoke of an implement.

FIG. 2 shows a perspective view of a second embodiment of a hitching mechanism.

FIG. 3 shows a side view of the embodiment of FIG. 2.

### DESCRIPTION OF THE PREFERRED EMBODIMENT(S)

The following detailed description illustrates by way of example and not by way of limitation. Described herein, among other things, are hitching mechanisms which provide for one handed towing of an implement through the use of an integrated handgrip, along with a one handed mechanism to both release and engage a hitch pin.

Throughout this disclosure, the hitching mechanism will be discussed as being attached to the yoke of an implement. This term “implement” is intended to broadly refer to any attachment which may be towed, an implement will generally be a tool such as a wagon or similar device designed to be used by being pulled, but may be of any type. Further, this disclosure refers to the implement being attached to a “tractor.” This term is not intended to be limited to a farm tractor or any other type of vehicle designed to operate in a field. Instead, the term “tractor” is intended to mean any vehicle (motorized or not) capable of towing an implement. Further, a tractor as used herein also includes another implement to the extent that multiple implements can be attached together (daisy chained) behind a tractor.

Two different embodiments of a hitching mechanism (100) are shown in the FIGS. The two systems share a number of common components but provide for different designs depending on the nature of the pin connection and the type of operation desired.

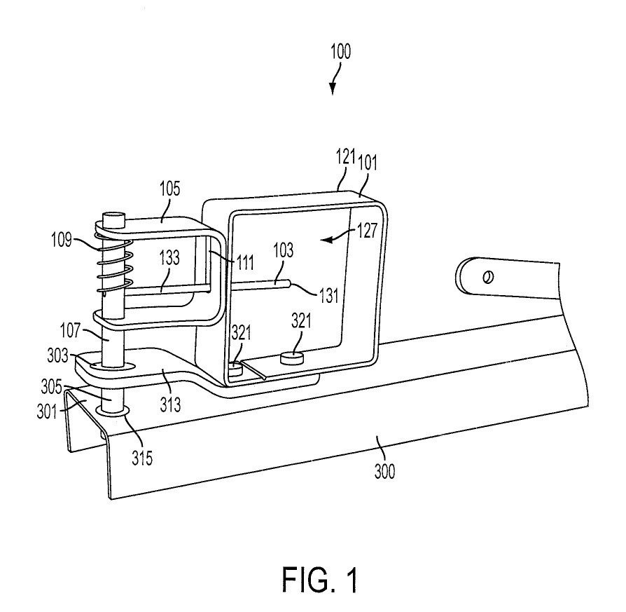

In the embodiment of FIG. 1 there is shown a hitching mechanism (100) which has been attached to a yoke (300) of an implement of the type traditionally pulled by a lawn tractor or similar device. The yoke (300) is adapted for a hitch pin connection to a tractor (not shown), specifically in this embodiment a lawn tractor or riding mower, by having two plates (313) and (315) with a space (301) therebetween. Each of the plates (313) and (315) has a hole (303) and (305) therethrough. This type of connection would allow for a mating plate (not shown) on a tractor with a similarly sized hole to be placed in gap (301), and then to have a hitch pin (107) placed through all three holes to connect the implement to the tractor.

In the embodiment of FIG. 1 the hitching mechanism (100) is attached to the upper surface of the yoke (300) and comprises four major structures. There is a handgrip (101) portion, a hitch pin support portion (105), a hitch pin (107) and a pin movement lever (103). The mechanism (100) is designed to serve both as a handhold, to enable easier movement of the implement by hand, and as a method for more easily retracting and extending the hitch pin (107) to connect or disconnect the implement to the tractor.

The handgrip (101) portion in this embodiment comprises a generally rigid generally rectilinear structure extending upward from the yoke. The top piece of this structure serves as the grip position (121) which may be grasped by a user to allow them to pull on the yoke (300) to move the implement by hand. In effect, the handgrip (101) is intended to provide for an improved structure designed to more easily allow the implement to be towed by the yoke (300) by hand. The front of the handgrip (101) includes a slot (111) through which the lever (103) passes. The lever (103) is also located at least partially within the structure of the handgrip (101) so as to be easily accessible to a user grasping the handgrip (101).

Towards the front of the handgrip (101), by the slot (111), there is attached a pin support portion (105) which serves to provide a support for the hitch pin (107) itself. The support (105), in this embodiment, comprises a generally U shaped bracket with two holes, one on each arm of the “U” and which is penetrated at the base of the “U” by the slot (111). The hitch pin (107) passes through the holes and is supported by the structure of the support (105). The support's (105) principle effect is to support the hitch pin (107) and provide it with a generally limited freedom of motion. Specifically, the support (105) serves to generally limit the motion of the pin to linear motion allowing the pin to be moved longitudinally in a generally “up and down” fashion. There is also included a biasing member (109) such as a coil spring which serves to bias the hitch pin (107) into a downward or closed position.

In the closed position the hitch pin (107) extends below the support (105), through a shim plate (313) and extends between the shim plate (313) and upper surface (315) of the yoke (300). The hitch pin (107) extends through hole (303), across the gap (301) between the shim (313) and the yoke (300) and into hole (305) when in the closed position. In this position, the yoke (300) would generally be held to a hitch on a tractor by having the hitch plate on the tractor be in the gap (301) with the hitch pin (107) through a hole in the hitch plate on the tractor with the hitch pin (107) holding the hitch plate in the gap (301) if the hitch plate was present. Also in this position, attachment of the hitch plate, if otherwise not connected, would generally be inhibited since the hitch pin (107) would be in the way of attachment.

The hitching mechanism (100) may also be adjusted and moved to an open position. In the open position, the hitch pin (107) is in a raised position relative to the yoke (300) allowing there to be at least some space not crossed by the pin (107) within the gap (301). In the open position, the yoke (300) is designed to be in the process of being attached or removed from a hitch plate on a tractor as the solid portion of the plate can pass between the holes (303) and (305).

The hitching mechanism (100) generally will also include a biasing mechanism (109) which is designed to hold the hitch pin (107) in the closed position until a force is applied to move the pin (107) to the open position. In this way, the hitching mechanism (100) will default to the closed position providing for connection safety as the hitch plate is not readily separated from the yoke (300) once connected.

Shifting of the hitch pin (107) between the open and closed position is performed by a manipulation of lever (103). The lever (300) is generally rigidly attached to the hitch pin (107) or to a structure which is in turn attached to the hitch pin (107). In the depicted embodiment, the lever (103) is designed to be raised and lowered by being able to move in a generally linear fashion in the plane including the longitudinal dimension of the hitch pin (107). This is also the same plane that includes the longitudinal dimension of the handgrip (101) and therefore produces a relatively narrow mechanism (100) which is seated entirely above the yoke (300) as can be seen in FIG. 1. The lever (103) is operated by raising or lowering it relative to the yoke (300) the lever (103) passing through the slot (111) which further constrains its available motion. This raising and lowering serves to move the hitch pin (107) in a similar fashion. In the depicted embodiment, the movement is generally performed by a user grasping the handgrip (101) with their fingers arranged under the handgrip (101) (in the void (127)). The user can open their fingers and grasp the portion of the lever (103) in the void (127), and they curl their fingers (e.g. by making a fist) to raise the lever (103) without releasing their grip on the handle (101).

The shim plate (313) is not required for operation, but provides for the ability to prevent the yoke (300) from being able to fall downward during attachment to the tractor and can also provide for adjustment to raise or lower the handgrip (101) relative to the yoke (300) to provide that the pin (107) extend through its gap when in the closed position and not when in the open position. Essentially, such adjustment can allow for hitch pins (107) of different length to be positioned so as to extend and retract, and have the correct throw distance. This can be particularly useful if the mechanism (100) is retrofit to an existing yoke (300) where it may previously have been the case that the yoke (300) was above the hitch plate on the tractor, or may have a pin of fixed, predetermined length. The bolts (321) can serve to provide for adjustment of the mechanism (100) relative to the yoke (300) such as by including washers between the handgrip (101) and shim (313) and/or between the shim (313) and yoke (300).

In operation, the mechanism (100) would generally work as follows. A user would grasp the handgrip (101) in one hand and pull on the handgrip (101) to direct the implement toward the tractor Once the implement is in proximity of the tractor, the user would place their fingers around the portion of lever (103) toward the first end (131) and generally within the handgrip (101) The user would then make an action to close their fist, squeezing the handgrip (101) and lever (103) together. This results in the lever (103) being pulled toward the handgrip (101).

As the lever (103) is lifted, the lever (103) will push the hitch pin (107) upward against the biasing member (109). The hitch pin (107) will generally be raised so as to be at least partially clear of the opening (301) and be in the open position. Still maneuvering the implement with handgrip (101). The user would then position the hitch plate on the tractor into the opening (301) and generally align the hole in the hitch plate on the tractor with holes (305) and (303). They would then release or loosen their grip on the lever (103) allowing the hitch pin (107) to be biased back toward the opening (305). In the event that the holes (305) and (303) were correctly aligned with the hole in the hitch plate on the tractor, the hitch pin (109) will then pass through the hole in the hitch plate on the tractor and into the hole (305).

If the holes were not quite aligned, the biasing member (109) will generally push the hitch pin (107) into contact with the hitch plate on the tractor. The user can then adjust the position of the yoke (300) using the handgrip (101) providing for a slight repositioning of the relative holes until the holes align, at which point the biasing member (109) will generally force the hitch pin (107) through the holes and into the closed position.

As can be seen from the above, the hitching mechanism (100) provides for a number of benefits over traditional hitch pin connections. Specifically, the mechanism (100) provides a generally integrated handgrip (101) allowing for the implement to be more easily pulled by hand and held during positioning of the implement to the tractor. Further, since the hitch pin (107) can be raised with the same hand utilizing the handgrip (101) and the lever (103) can provide for mechanical advantage, it is generally possible to place the implement on the tractor using only a single hand. Further, since the hitch pin (107) is biased into a position where it crosses the gap (301) (closed position), in the event that the hitch pin (107) is not correctly positioned on the first try, the user does not need to hold the pin (107) in place with one hand while trying to adjust the position of the yoke (300) with the other to try and get the hitch pin (107) into the closed position. Instead, the user only needs a single hand to adjust the position of the implement relying on the biasing member (109) to push the hitch pin (107) downward as soon as it is able. Further, the squeezing motion to raise or lower the hitch pin (107) is a natural and straightforward motion and is generally within the plane of the handgrip (101) providing that the motion is linear and relatively easy to perform. It also allows the mechanism (100) to be compactly positioned on the yoke (300).

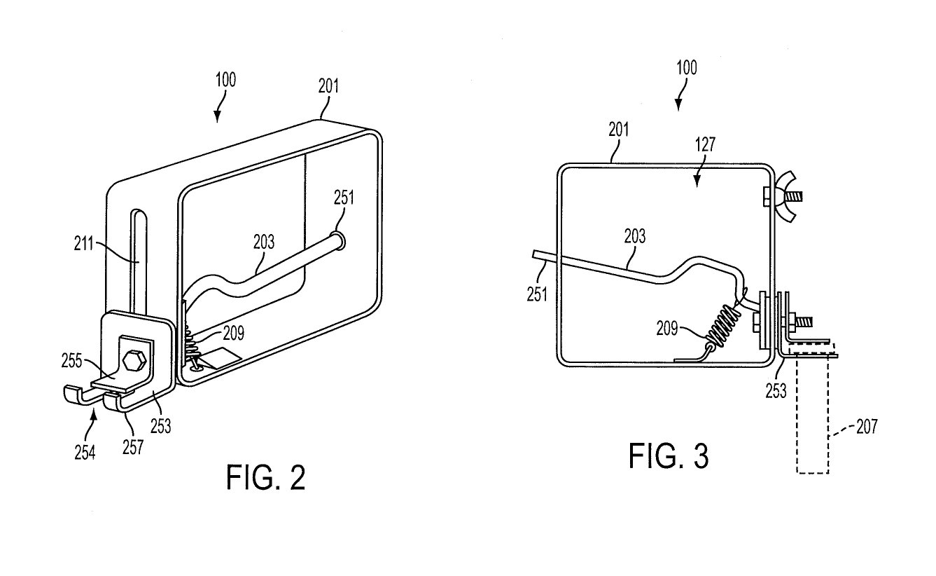

FIGS. 2 and 3 provide for drawings of an alternative embodiment of a hitching mechanism (100). The general operation and structure are the same in the embodiment of FIGS. 2 and 3 as it was in FIG. 1, however in this embodiment the handgrip (201) is the only principle support structure. The lever (203) is also arranged so that it does not pull up vertically as in the embodiment of FIG. 1, but instead can pivot about a pivot point (251). This can provide for additional leverage in resisting the biasing mechanism (209) and also a more comfortable motion. The biasing mechanism (209) is also arranged so as to act on the lever (203) directly instead of directly on the hitch pin (107). The device in these figures also includes a hitch pin mount (253). This structure is designed to connect with a standard hitch pin (107) which is generally bolt shaped and has an upper flange. The mount (253) includes two pieces. An upper clamp part (255) and a lower clamp part (257). The lower clamp part is generally “U” or “O” shaped so that it has an orifice (259) through which the hitch pin (107) can be passed but which supports the flange. The flange of the hitch pin (107) then rests on the upper surface of the lower portion (257) as indicated in FIG. 3 and the upper portion is used to secure the pin (107) so that it generally cannot move up or down relative to the mount (253) but can move with the mount (253). As this design can be easily used with an existing hitch pin (107), it can allow for the hitching mechanism (100) to be retrofitted by mounting on a shim plate (313) on an existing yoke (300) to adjust height and provide positioning without need to match the pin size or shape so as to interface with the holes.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A hitching mechanism comprising:
a handgrip, such handgrip being connected to a yoke such that an implement can be moved by hand by pulling on the handle;
a hitch pin, said hitch pin being capable of generally linear movement relative to said yoke such that said hitch pin can move between a closed position, where it extends across a gap, and an open position where it does not extend across said gap;
a lever, said lever being able to move said hitch pin from said closed to said open position; and
a biasing mechanism, said biasing mechanism biasing said hitch pin to said closed position;
wherein, a user can grasp said handgrip and operate said lever with a single hand.

2. The mechanism of claim 1 wherein said handgrip is generally part of a rectilinear structure attached to said yoke.

3. The mechanism of claim 1 wherein said hitching mechanism is placed on a shim plate such that said gap is between said yoke and said shim plate.

4. The mechanism of claim 1 wherein said biasing system comprises a coiled spring.

5. The mechanism of claim 1 wherein said lever pivots about a point.

6. The mechanism of claim 1 wherein said lever slides in a generally linear fashion along with said hitch pin.

7. The mechanism of claim 1 wherein said mechanism further comprises a hitch mount which holds said hitch pin.

8. The mechanism of claim 7 wherein said mechanism is retrofitted to an existing yoke having a hitch pin connector including an existing hitch pin and said existing hitch pin is attached to said hitch mount.

9. The mechanism of claim 1 wherein said user operates said lever by opening or closing their fist while said lever and said handgrip are in their hand.

10. The mechanism of claim 9 wherein said lever moves toward said handgrip when said hitch pin is moved to said open position.

11. The mechanism of claim 10 wherein said motion is generally within a plane including a longitudinal dimension of said handgrip and a longitudinal dimension of said hitch pin.

12. A system for hitching an implement to a tractor, the system comprising:
an implement including a yoke; and
a hitching mechanism attached to said yoke, said mechanism including:
a handgrip, said handgrip being designed for pulling said implement by hand;
two plates separated by a gap, each of said plates including a hole;
a hitch pin, said hitch pin being capable of moving from a closed position where said hitch pin engages both said holes and crosses said gap, and an open position where said hitch pin does not cross said gap;
a biasing mechanism for biasing said hitch pin into said closed position; and
a lever, said lever being attached to said hitch pin and capable of movement in a generally linear fashion to move said hitch pin from said closed to said open position.

13. The system of claim 12 further comprising a tractor, said tractor having a hitch plate with a hole, said hole being engaged by said hitch pin when said implement is attached to said tractor.

14. The system of claim 13 wherein said tractor comprises a garden tractor.

15. The system of claim 13 wherein said tractor comprises a riding lawn mower.

16. The system of claim 12 wherein said lever is engaged by a user's hand which is also in contact with said handgrip.

17. The system of claim 16 wherein said lever is moved by making a fist with said user's hand.

18. A method for hitching an implement to a tractor, the method comprising:
providing an implement including a yoke and a tractor;
supplying on said yoke a hitching mechanism, said mechanism including:
a handgrip, said handgrip being designed for pulling said implement by hand;
two plates separated by a gap, each of said plates including a hole;
a hitch pin, said hitch pin being capable of moving from a closed position where said hitch pin engages both said holes and crosses said gap, and an open position where said hitch pin does not cross said gap;
a biasing mechanism for biasing said hitch pin into said closed position; and
a lever, said lever being attached to said hitch pin and capable of movement in a generally linear fashion to move said hitch pin from said closed to said open position;
grasping said handgrip with a user's hand;
grasping said lever with said user's hand;
said user's hand moving said lever to move said hitch pin to said open position;
placing a hitch plate on a tractor, said hitch plate including a hole in said gap; and
allowing said biasing member to bias said hitch pin into said closed position, said hitch pin extending through said hole once so biased.
